(19) United States
(12) Patent Application Publication
(10) Pub. No.: US 2015/0042653 A1
(43) Pub. Date: Feb. 12, 2015

(54) 3D Display Device

(71) Applicant: Yasuhiro Takaki, Fuchu-shi (JP)

(72) Inventor: Yasuhiro Takaki, Fuchu-shi (JP)

(21) Appl. No.: 14/129,873

(22) PCT Filed: Jul. 5, 2012
(86) PCT No.: PCT/JP2012/067192

§ 371 Date: Mar. 27, 2014

(30) Foreign Application Priority Data
Jul. 5, 2011 (JP) 2011-148825

(51) Int. Cl. G03B 21/56; H04N 13/04; G03B 21/60

(52) U.S. Cl. CPC G03B 21/562; G03B 21/567; G03B 21/602; H04N 13/0459
USPC 345/426; 353/7

(57) ABSTRACT

In the present invention, high-quality 3D images can be displayed using a simple configuration. A rotating screen, comprising a lens which is set at a position such that the rotational center of the lens is eccentric in relation to a light axis, is rotationally driven. A plurality of projectors are disposed offset from the rotational center axis of the rotating screen.

### TECHNICAL FIELD

The present invention relates to a 3D display device that allows observation of a displayed object from the entire circumference.

### BACKGROUND ART

Various 3D display devices have been proposed that allow observation of a displayed object from the entire circumference. Such 3D display devices can be broadly classified into those allowing observation of a vertical display surface from the entire circumference and those allowing observation of a horizontal display surface from the entire circumference.

FIG. 18 illustrates an example of the former among these two types of 3D display devices. This 3D display device 1 is provided with a mirror 2 that reflects an image that is incident from above, and the mirror 2 rotates at high speed. In the 3D display device 1, the image that is in sync with the rotation of the mirror 2 is emitted from a projector 3 disposed above and redirected by the mirror 2 to be output to the circumference. As a result, the 3D display device 1 displays a desired 3D image in such a way that the output light from the mirror 2 is visible from the circumference (A. Jones, I. McDowall, H. Yamada, M. Bolas, and P. Debevec, “Rendering for an Interactive 360° Light Field Display,” ACM SIGGRAPH 2007.)

FIG. 19 illustrates another example of the former among the two types of 3D display devices. The 3D display device 6 rotates a screen 7 and selectively reflects an image emitted by a plurality of projectors 8A, 8B, . . . 8N, . . . that are disposed in the circumstances, by rotation of the screen 7. As a result, the 3D display device 6 displays a desired 3D image in such a way that an image displayed on the screen 7 is visible from various directions (R. Otsuka, T. Hoshino, and Y. Horry, “Transport: A novel approach to the display and transmission of 360 degrees viewable 3D solid images,” IEEE Trans. Vis. Comput. Graph. 12, 178-185 (2006).)

FIG. 20 illustrates another example of the former among the two types of 3D display devices. In the 3D display device 11, an LED array 12 formed by sequentially arranging LEDs in a vertical direction is disposed at a predetermined pitch on an outer periphery of an inner tube rotator 13 in a tubular shape, the inner tube rotator 13 being rotationally driven at a predetermined rotation rate. An outer tube rotator 14 is disposed around the inner tube rotator 13 coaxially with the inner tube rotator 13, the outer tube rotator 14 being rotationally driven in an opposite direction to that of the inner tube rotator 13. In the 3D display device 11, slits 15 are provided on the outer tube rotator 14. Through the slits 15, a 3D image is displayed while the LED array 12s are driven in sync with the rotation of the inner tube rotator 13 and the outer tube rotator 14 (T. Endo, Y. Kajiki, T. Honda, and M. Sato, “Cylindrical 3D video display observable from all directions,” 8th Pacific Conference on Computer Graphics and Applications, 300-306.)

FIG. 21 illustrates an example of the latter among the two types of 3D display devices. In this 3D display device 16, a planar screen 17 in a disk like shape is rotationally driven about a center as a rotational axis. Here, the planar screen 17 is composed of a hologram that bends an optical path of light that is incident from below and outputs in a desired direction. In the 3D display device 16, a projector 18 is disposed under the planar screen 17. The 3D display device 16 thus configured emits an image from the projector 18 in sync with the rotation of the planar screen 17, to thereby display a desired 3D image (H. Horimai, D. Horimai, T. Kouketsu, P. B. Lim, and M. Inoue, “Full-Color 3D Display System with 360 Degree Horizontal Viewing Angle,” The International Symposium of 3D and Contents 2010.)

FIG. 22 illustrates another example of the latter among the two types of 3D display devices. In this 3D display device 19, projectors 21A, 21B, . . . 21N, . . . are sequentially arranged around a conical screen 20 with an upper end being open. The 3D display device 19 renders images output from the projectors 21A, 21B, . . . 21N, . . . visible from various directions through the conical screen 20, to thereby display a 3D image (S. Yoshida, S. Yano, and H. Ando, “Glasses-free Table-style 3D Display Observed from Surrounding Viewpoints: A Study of Displaying Principle and Prototyping,” Journal of the Virtual Reality Society of Japan, 15,121-124 (2010).)
[Non-Patent Document 1] A. Jones, I. McDowall, H. Yamada, M. Bolas, and P. Debevec, “Rendering for an Interactive 360° Light Field Display,” ACM SIGGRAPH 2007.
[Non-Patent Document 2] R. Otsuka, T. Hoshino, and Y. Horry, “Transpost: A novel approach to the display and transmission of 360 degrees viewable 3D solid images,” IEEE Trans. Vis. Comput. Graph. 12, 178-185 (2006).
[Non-Patent Document 3] T. Endo, Y. Kajiki, T. Honda, and M. Sato, “Cylindrical 3D video display observable from all directions,” 8th Pacific Conference on Computer Graphics and Applications, 300-306.
[Non-Patent Document 4] S. Yoshida, S. Yano, and H. Ando, “Glasses-free Table-style 3D Display Observed from Surrounding Viewpoints: A Study of Displaying Principle and Prototyping,” Journal of the Virtual Reality Society of Japan, 15, 121-124 (2010).

### SUMMARY OF THE INVENTION

### Problems to be Solved by the Invention

These conventional 3D display devices still have problems that inhibit practical use thereof. That is, the 3D display devices 1 and 16 of the configurations of FIGS. 18 and 21 (hereinafter referred to as “high-speed projector type”) have a limited frame rate of the projectors 3 and 18 and a limited rotation rate of the mirror 2 and the planar screen 17, that inhibit display of a sufficiently high quality 3D image. More specifically, the 3D display devices 1 and 16 have a problem of restriction on the number of images that can be displayed to the entire circumference and restriction on the number of gray levels in each image. In addition, in these devices, it is difficult to increase the frame rate of each image constituting a 3D display, and flickering may arise. Furthermore, in the 3D display device 11 illustrated in FIG. 18, a 3D image is generated in the vicinity of the mirror 2 and makes interaction between the 3D image and a fingertip difficult.

Meanwhile, the 3D display devices 6 and 19 illustrated in FIGS. 19 and 22 (hereinafter referred to as “projector array type”) that require a large number of projectors are bulky and complex as a whole, and have problems of space, cost, reliability, and maintainability. In addition, in the 3D display device 6 of FIG. 19, the screen 7 must be rotated at high speed and a 3D image is generated in the vicinity of the screen 7 and makes interaction between the 3D image and a fingertip difficult.

Furthermore, in the 3D display device 11 illustrated in FIG. 20, a 3D image is generated inside the outer tube rotator 14 and makes interaction between the 3D image and a fingertip difficult. Moreover, the rotators 13 and 14 which must be rotated at high speed can deteriorate mechanical stability of the device.

The present invention proposes a 3D display device that can solve these problems and allow display of a high quality 3D image with a simple configuration.

### Means for Solving the Problems

In a first aspect of the present invention, a 3D display device includes: a rotational screen of which rotation axis is disposed in a displaced manner with respect to an optical axis, the rotational screen being configured to change an emission direction of incident ray sequentially by rotation about the rotation axis; and

a plurality of projectors that is disposed in an offset manner with respect to the rotation axis of the rotational screen and emits images onto the rotational screen.

According to the first aspect, the output direction from the rotational screen of the output light of each projector changes according to rotation of the rotational screen, to thereby allow setting of a viewpoint in each output direction and display of the 3D image. In addition, by disposing the projectors in an offset manner with respect to the rotation axis, the plurality of projectors can be disposed while securing sufficient spaces. This allows sharing of display of a 3D image among the plurality of projectors, thereby realizing display of a high quality 3D image with a simple configuration.

According to a second aspect of the present invention, in the 3D display device as described in the first aspect, the rotational screen has, in addition to a function as a lens, a function of diffusing light in a direction of a line virtually connecting the rotational center with the optical axis.

According to the second aspect, a viewpoint can be enlarged in a direction of diffusing light.

According to a third aspect of the present invention, in the 3D display device as described in the first or second aspect, the rotational screen is a reflective lens.

According to the third aspect, a 3D image can be displayed on a side of the rotational screen on which the projector is disposed. Given this, a configuration of a side that is opposite thereto can be simplified and the rotational mirror can be driven by a simple configuration.

According to a fourth aspect of the present invention, in the 3D display device as described in the third aspect, the rotational screen has, in addition to a function as a lens, a function of diffusing light in a direction connecting the rotational center with the light axis.

According to the fourth aspect, the viewpoint can be enlarged in a direction of diffusing light in the configuration of the third aspect.

According to a fifth aspect of the present invention, in the 3D display device as described in the first, second, third, or fourth aspect, the plurality of projectors is respectively driven by image data of each of color signals constituting a color image.

According to the fifth aspect, the display of a 3D image can be realized by sharing of color signals constituting a color image among the plurality of projectors.

According to a sixth aspect of the present invention, in the 3D display device as described in the first, second, third, or fourth aspect, the plurality of projectors is configured such that an emission light intensity increases sequentially and gradually; assigned with a bit constituting image data for 3D display, according to the configuration of the emission light intensity; and driven by data of the bit thus assigned.

According to the sixth aspect, the display of a 3D image can be realized by sharing of bits of image data among the plurality of projectors.

According to a seventh aspect of the present invention, in the 3D display device as described in the first, second, third or fourth aspect, the plurality of projectors emits images sequentially and cyclically, by rotation of the rotational screen.

According to the seventh aspect, the display of a 3D image can be realized by sharing of a viewpoint among the plurality of projectors.

According to the present invention, a high quality 3D image can be displayed with a simple configuration.

### BRIEF DESCRIPTION OF THE DRAWINGS

FIG. 1 is a drawing that describes a principle of a 3D display device according to the present invention;

FIG. 2 is a drawing that describes a viewpoint in the configuration of FIG. 1;

FIG. 3 is a drawing serving for description following FIG. 1;

FIG. 4 is a drawing that describes a viewpoint in the configuration of FIG. 3;

FIG. 5 is a drawing serving for description following FIG. 3;

FIG. 6 is a drawing that describes a configuration for supplying output light from a projector to each viewpoint, by means of a converging ray, a parallel ray, and a diverging ray;

FIG. 7 is a table showing comparison with conventional configurations;

FIG. 8 is a drawing illustrating a 3D display device of the first embodiment of the present invention;

FIG. 9 is a drawing that describes a rotational screen of the 3D display device illustrated in FIG. 8;

FIG. 10 is a drawing illustrating a 3D display device of the second embodiment of the present invention;

FIG. 11 is a drawing that describes operation of the 3D display device illustrated in FIG. 10;

FIG. 12 is a drawing illustrating a 3D display device of the third embodiment of the present invention;

FIG. 13 is a drawing illustrating a 3D display device of the fourth embodiment of the present invention;

FIG. 14 is a drawing illustrating a 3D display device of the fifth embodiment of the present invention;

FIG. 15 is a drawing that describes a principle of another 3D display device according to the present invention;

FIG. 16 is a drawing that describes a viewpoint in the configuration of FIG. 15;

FIG. 17 is a drawing illustrating a 3D display device of the sixth embodiment of the present invention;

FIG. 18 is a drawing illustrating a conventional 3D display device;

FIG. 19 is a drawing illustrating a conventional 3D display device, different from that of FIG. 15;

FIG. 20 is a drawing illustrating a conventional 3D display device with LED arrays;

FIG. 21 is a drawing illustrating a conventional 3D display device, employing a different system from those of the examples of FIGS. 18, 19, and 20; and

FIG. 22 is a drawing illustrating a 3D display device, employing a different system from that of FIG. 21.

### DETAILED DESCRIPTION OF THE INVENTION

The embodiment of the present invention is described hereinafter with reference to the Drawings.

### [Principle of Operation]

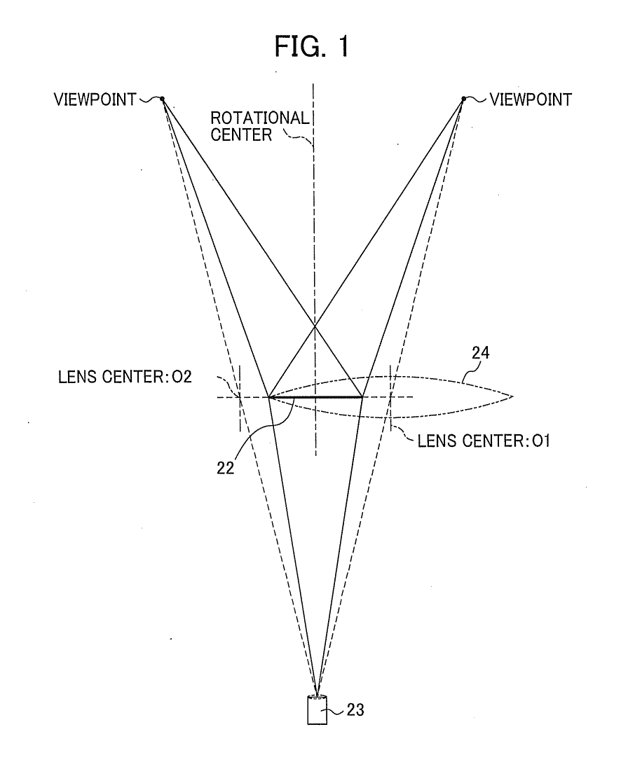

FIG. 1 is a cross-sectional view that describes a principle of the 3D display device according to the present invention. The optical system illustrated in FIG. 1 rotationally drives a rotational screen 22 about a rotational center. In addition, a projector 23 is disposed on the rotational axis of the rotational screen 22, the projector 23 projecting an image on the rotational screen 22. Here, as shown by a broken line, the rotational screen 22 is obtained by cutting out a part of a convex lens 24 in a circular shape. A center of the circular shape is set as a rotational center, which is positioned eccentrically with respect to an optical axis of the convex lens 24.

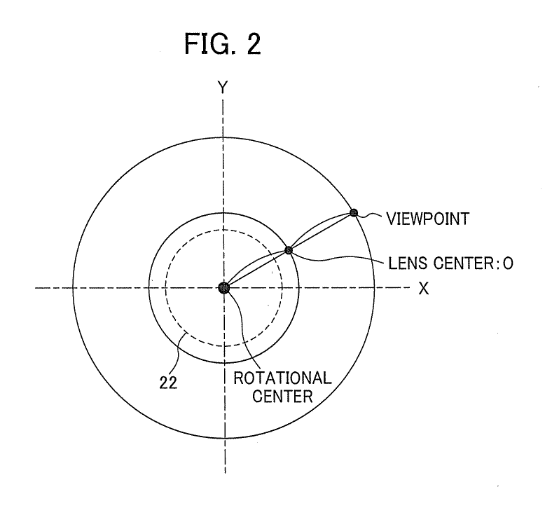

In this optical system, as shown by a broken line, output light from the projector 23 is condensed on a straight line connecting a lens center (position of the optical axis, which is an optical center) and the projector 23, and a viewpoint is provided at a condensing position. It should be noted that the projector 23 is disposed farther than a focal plane of the rotational screen 22. In this optical system, since the rotational center of the rotational screen 22 is offset with respect to the lens center, the lens center O of the rotational screen 22 rotates about the rotational center of the rotational screen 22 as the rotational screen 22 rotates, as shown in FIG. 2. As a result, the position of the viewpoint is changed about the rotational center of the rotational screen 22. In other words, as the rotational screen 22 makes a half turn, the lens center moves from a position indicated by O1 to a position indicated by O2 in FIG. 1 and the position of the viewpoint also displaces accordingly. As a result, the optical system illustrated in FIG. 1 can display a 3D image by sequentially switching images projected by the projector 23 in sync with the displacement of the viewpoint.

The rotational screen 22 may be configured to have, in addition to a function as a lens (lens function), a function of diffusing output light in one direction (one-directional diffusion function). It should be noted that the direction of diffusing the output light is a direction connecting the lens center and the rotational center. In this case, the viewpoint, which is the condensing position shown in FIG. 1, is enlarged in a vertical direction, while the position of the viewpoint in a horizontal direction shown in FIG. 2 is not affected. As a result, the viewpoint is enlarged only in the vertical direction, thereby allowing observation of a 3D image from various heights.

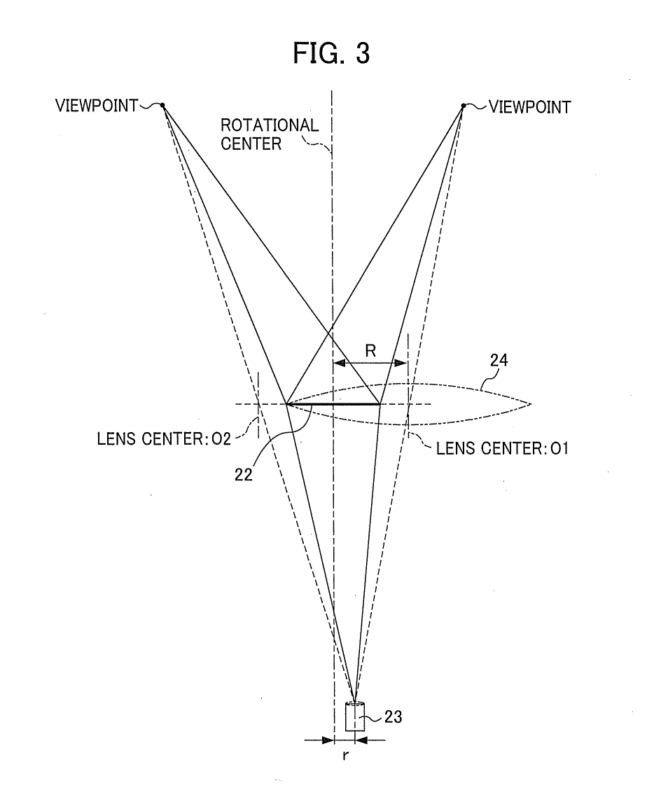

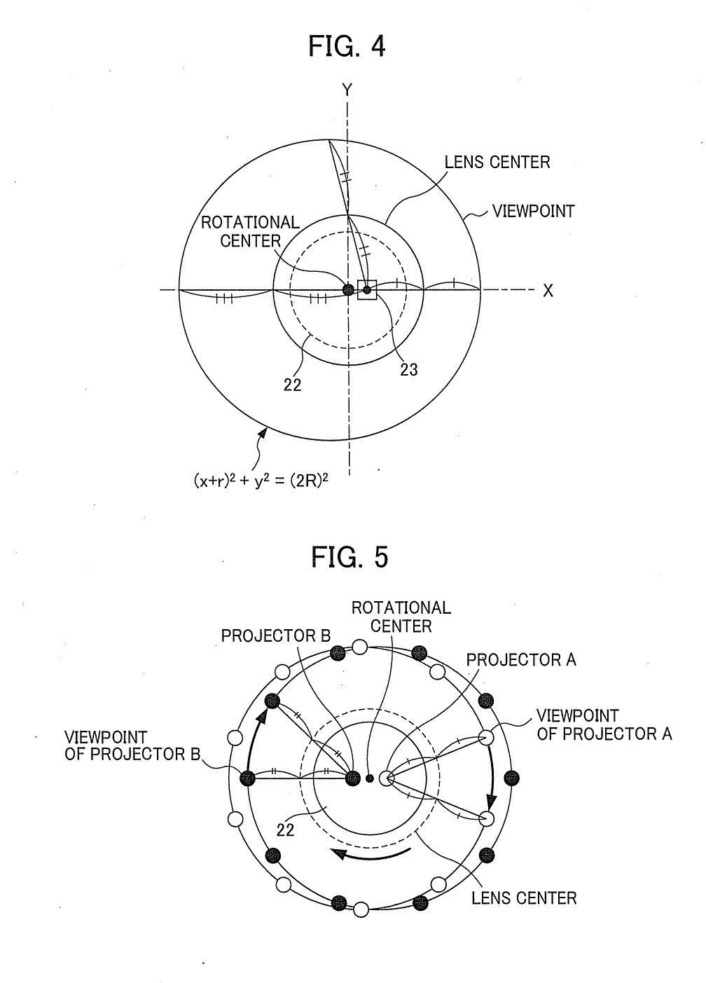

Unlike the configuration of FIG. 1, in FIG. 3, the projector 23 is disposed at a position offset with respect to the rotational center of the rotational screen 22 by a predetermined distance. Here, a distance between the lens center O (O1, O2) and the rotational center is referred to as R and an offset amount of the projector 23 (distance between the rotational center of the rotational screen 22 and the optical axis of the projector 23) is referred to as r. In this case, displacement of the viewpoint according to the rotation of the rotational screen 22 can be calculated by imaging formula relating to the rotational screen 22. FIG. 4 is a diagram illustrating the displacement of the viewpoint. As shown in FIG. 4, in a case of disposing the projector 23 in an offset manner, the viewpoint is sequentially formed in the periphery of the rotational center as in a case of disposing the projector 23 on the rotation axis of the rotational screen 22; however, the position of the viewpoint is eccentric with respect to the rotational center. In FIG. 4, trajectories of the viewpoint are indicated in an orthogonal coordinate system with the rotational center as a coordinate origin.

In the example of FIG. 3, by disposing the projector 23 in an offset manner with respect to the rotation axis, the plurality of projectors can be disposed. FIG. 5 is a diagram showing trajectories of the viewpoint in a case of disposing first and second projectors A and B in a symmetrical manner across the rotational central axis. In this case, the trajectories of the viewpoints by the two projectors are formed at positions that are different by the offset amount of the two projectors with respect to the rotation axis; a 3D image can be displayed in a shared manner by these two projectors, by synthesizing images seen from the viewpoints on these two trajectories and then projecting by corresponding projectors. Given this, by thus setting driving of these two projectors, various problems of the conventional configurations can be solved at once and an image of higher quality than that of the conventional configurations can be displayed by a simple configuration. In addition, various problems relating to arranging of projectors can efficiently be avoided.

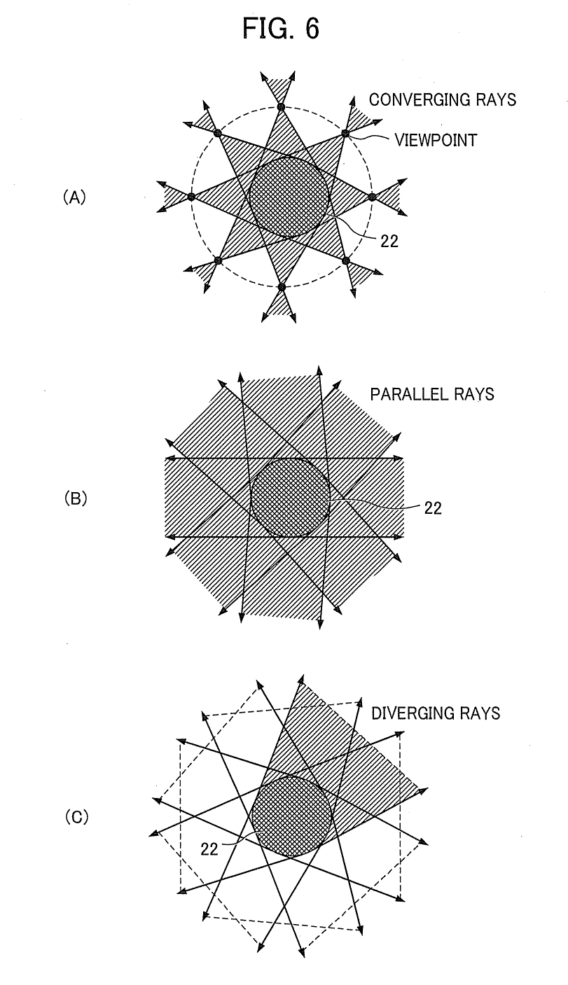

Furthermore, in the present configuration of the optical system, by changing the configuration of the rotational screen 22, a state of light used for displaying image can be changed in various ways. In other words, as shown in FIG. 6(A), by disposing the projector 23 at a position away from the focal plane of the rotational screen 22, the output light from the projector 23 can be condensed at the viewpoint by the rotational screen 22, as described above. Accordingly, by disposing the projector 23 at the focal plane of the rotational screen 22, the output light of the projector 23 can be guided to each viewpoint by parallel rays, as shown in FIG. 6(B). Alternatively, by disposing the projector 23 at a position more inward than the focal plane of the rotational screen 22, the output light of the projector 23 can be output by diverging rays, as shown in FIG. 6 (C). By selecting arrangement of the projector 23 as necessary, divergence of light from the projector at the viewpoint can be changed in various ways. Although the rotational screen has been described as a positive lens exemplified by a convex lens, a negative lens can also be employed. In this case, diverging rays can be output as in the example of FIG. 6 (C).

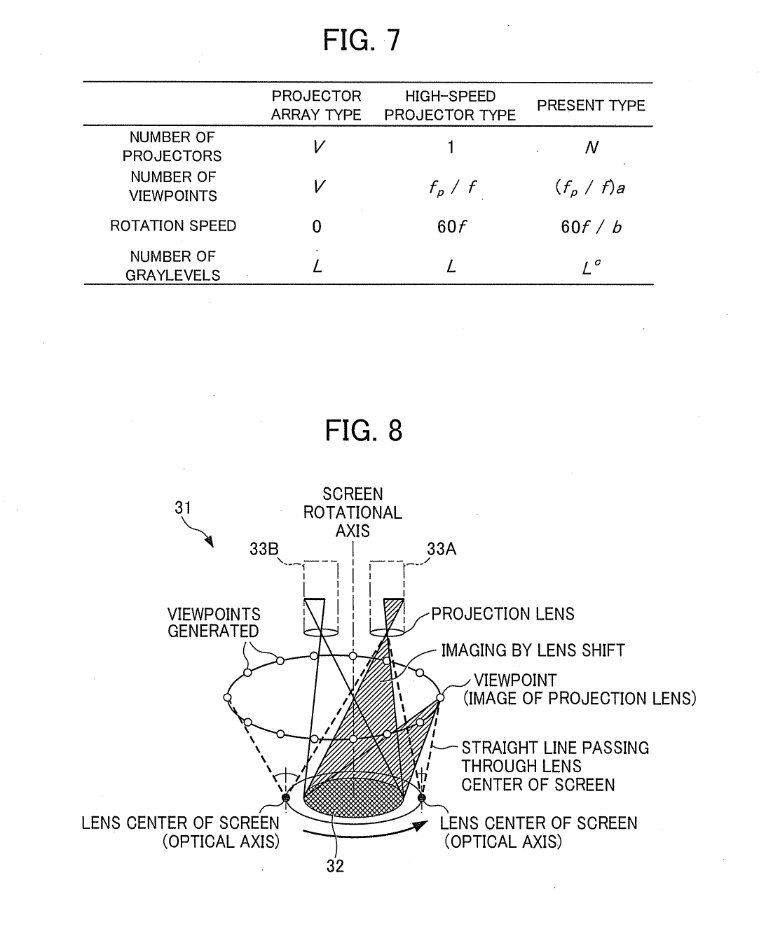

FIG. 7 is a table showing comparisons between 3D display devices of the conventional systems and that of the present system. In a projector array type device, V projectors are necessary for securing the number V, the number of viewpoints. In addition, the number of gray levels in each image is the number L, the number of gray levels that each projector has. In a high-speed projector type device, only one projector is necessary; however, the number of viewpoints is fp/f. Here, fp represents a frame rate, of the projector and f represents a frame rate of each image constituting a 3D image. In this case, the rotation speed of the mirror or screen is 60 f and the number of gray levels is L, the number of gray levels of the projector.

On the other hand, in the configuration according to the principle described above, the increased number of projectors can be linked with the increased number of frame rate and the increased number of gray levels of each image constituting the 3D image, as well as the increased number of viewpoints. In other words, in such a configuration, given the number of projectors N, under a condition of constraint abc=N, the number of viewpoints can be set to (fp/f)a; the rotation speed of the rotational screen can be set to 60 f/b; and the number of gray levels can be set to L to the c-th.

In addition, in such a configuration, a 3D image formed on the rotational screen can be observed from the entire circumference; furthermore, a 3D image can be displayed in a space without a screen or the like. This allows interaction between the 3D image and a fingertip.

### First Embodiment

FIG. 8 is a drawing illustrating a 3D display device of the first embodiment of the present invention. In this 3D display device 31, a rotational screen 32 in a disk like shape is provided and the rotational screen 32 is rotationally driven about a central axis thereof as a rotational axis. In the 3D display device 31, first and second projectors 33A and 33B are disposed above the rotational screen 32, at positions offset with respect to the rotation axis by a predetermined distance, so as to oppose each other at 180 degrees across the rotational central axis.

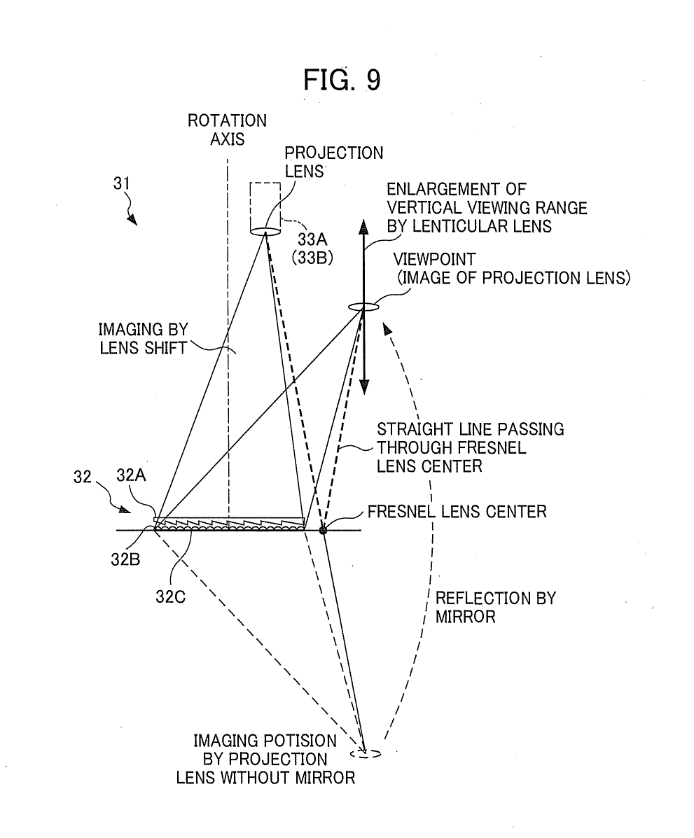

Here, as shown in FIG. 9, the rotational screen 32 is configured with: a rotational screen main body 32A; a lenticular lens 32B; and a mirror 32C that are sequentially arranged in this order from a side of projectors 33A, 33B. Here, the rotational screen main body 32A is a convex lens having a center eccentric with respect to the optical axis similar to that described above in FIG. 1 and the like, and, in the present embodiment, is composed of a Fresnel lens. The lenticular lens 32B is a one-dimensional array of one-dimensional lenses that functions as a one-directional diffuser having a one-directional diffusion function, and is directed such that a direction of array of the one-dimensional lenses is a direction of a line connecting the lens center and the rotational center of the rotational screen. As a result, the 3D display device 31 reflects the output light from the projectors 33A, 33B that are disposed thereabove by means of the mirror 32C, and generates viewpoints for 3D display on a side on which the projectors 33A, 33B are disposed. In the 3D display device 31, by thus generating viewpoints for 3D display on a side on which the projectors 33A, 33B are disposed, a configuration for driving the rotational screen 32 can be simplified.

In the above described configuration, by disposing the plurality of projectors oppositely to the rotational screen, which is composed of a convex lens of which rotational center is eccentrically positioned with respect to the optical axis, in an offset manner with respect to the rotation axis thereof, problems of the conventional configurations can be solved at once and a 3D image of higher quality can be displayed by a simple configuration.

In addition, by configuring the rotational screen with: a Fresnel lens as a convex lens; a mirror; and a lenticular lens disposed between the Fresnel lens and the mirror that diffuses the transmitted light in a direction of a line connecting the rotation axis with the center of the Fresnel lens, the configuration for driving the rotational screen can be simplified.

### Second Embodiment

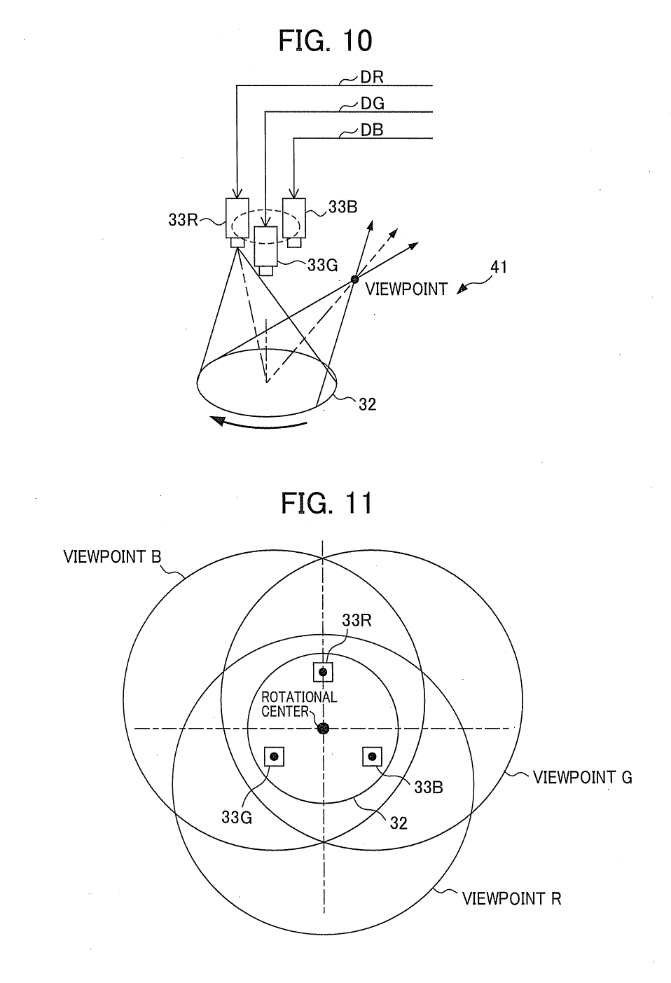

FIG. 10 is a drawing illustrating a 3D display device of the second embodiment of the present invention. In the 3D display device 41, three projectors 33R, 33G, 33B are disposed in an offset manner with respect to the rotation axis of the rotational screen 32, at angular intervals of approximately 120 degrees. The 3D display device 41 is configured similarly to the 3D display device 31 illustrated in FIG. 8, except for a difference in the configuration of the three projectors 33R, 33G, 33B.

Here, the 3D display device 41 drives the projectors 33R, 33G, 33B respectively by image data DR, DG, DB of color signals constituting a color image, thereby realizing display of a 3D image in a shared manner by the plurality of projectors 33R, 33G, 33B. The projectors 33R, 33G, 33B are respectively configured to display only image of the corresponding color signal. As a result, as shown in FIG. 11, in the 3D display device 41, the projectors 33R, 33G, 33B form trajectories of three viewpoints R, G, B around the rotational center of the rotational screen 32 as the center.

In the present embodiment, by arranging the plurality of projectors oppositely to the rotational screen, which is composed of the convex lens of which rotational center is positioned eccentrically with respect to the optical axis, in an offset manner with respect to the rotation axis thereof, and by displaying a color image by the plurality of projectors that share the color signals constituting the color image, a 3D image constituted of color images with high color representation can be displayed in high quality with a simple configuration.

### Third Embodiment

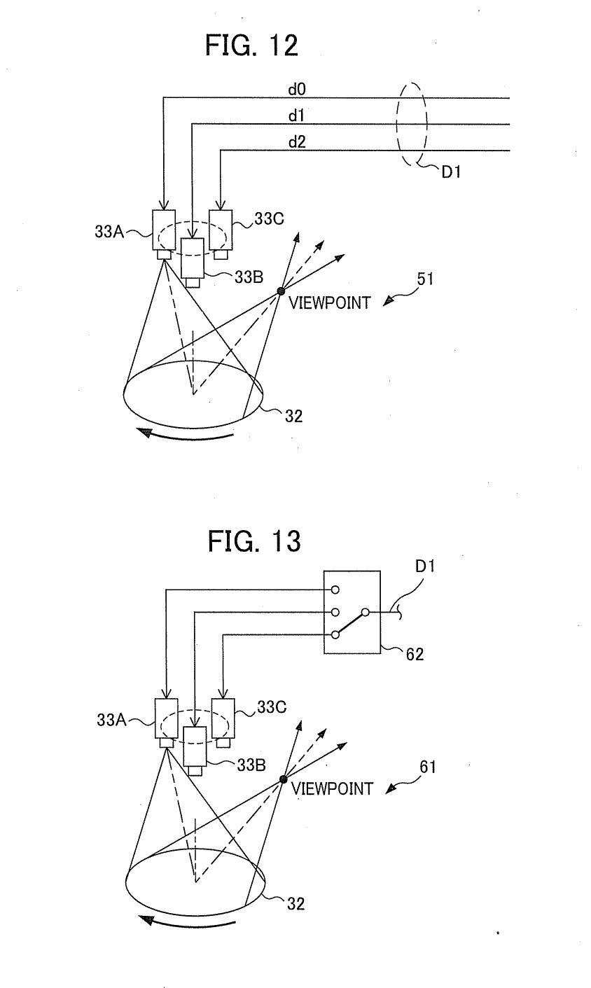

FIG. 12 is a drawing illustrating a 3D display device of the third embodiment of the present invention. In the 3D display device 51, three projectors 33A, 33B, 33C are disposed in an offset manner with respect to the rotational central axis of the rotational screen 32, at angular intervals of approximately 120 degrees. The 3D display device 51 is configured similarly to the 3D display device 31 illustrated in FIG. 8, except for a difference in the configuration of the three projectors 33A, 33B, 33C.

Here, the projectors 33A, 33B, 33C are configured such that maximum output light intensities increase sequentially by powers of 2. More specifically, the maximum output light intensity of the projector 33B is set to be twice of the maximum output light intensity of the projector 33A. In addition, the maximum output light intensity of the projector 33C is set to be twice of the maximum output light intensity of the projector 33B.

The 3D display device 51 displays a 3D image based on 3-bit image data D1 and drives the projector 33A having the smallest output light intensity, by means of a least significant bit d0 of the 3-bit image data. In addition, the device 51 drives the projector 33B having the second smallest output light intensity by means of a subsequent bit d1, and then the projector 33C having the greatest output light intensity, by means of a most significant bit d2. As a result, in the present embodiment, the display of a 3D image can be realized by sharing of bits of image data D1 among the plurality of projectors 33A, 33B, 33C.

In the present embodiment, by arranging the plurality of projectors oppositely to the rotational screen, which is composed of the convex lens of which rotational center is positioned eccentrically with respect to the optical axis, in an offset manner with respect to the rotation axis thereof, and by displaying a 3D image by the plurality of projectors sharing bits of the image data, a 3D image of high dynamic range can be displayed with a simple configuration.

### Fourth Embodiment

FIG. 13 is a drawing illustrating a 3D display device of the fourth embodiment of the present invention. In the 3D display device 61, three projectors 33A, 33B, 33C are disposed in an offset manner with respect to the rotation axis of the rotational screen 32, at angular intervals of approximately 120 degrees. The 3D display device 61 is configured similarly to the 3D display device 31 illustrated in FIG. 8, except for a difference in the configuration of the three projectors 33A, 33B, 33C.

In the 3D display device 61, the image data D1 is supplied to the projectors 33A, 33B, 33C sequentially and cyclically via a selector 62 that switches contact points sequentially and cyclically, and the projectors 33A, 33B, 33C respectively output image light intermittently by input of corresponding image data, in response to the sequential and cyclical supply of the image data. As a result, the 3D display device 61 performs display of the 3D image by sharing of a viewpoint among the plurality of projectors.

In the present embodiment, by arranging the plurality of projectors oppositely to the rotational screen, which is composed of the convex lens of which rotational center is positioned eccentrically with respect to the optical axis, in an offset manner with respect to the rotational central axis thereof, and by displaying a 3D image by the plurality of projectors sharing the viewpoint, a 3D image can be displayed with a simple configuration while increasing the number of viewpoints for 3D display and increasing the number of images that can be displayed in the entire circumference.

### Fifth Embodiment

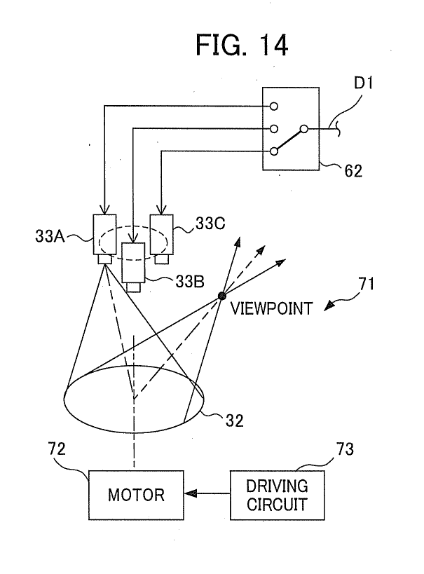

FIG. 14 is a drawing illustrating a 3D display device of the fifth embodiment of the present invention. The 3D display device 71 is configured similarly to the 3D display device 61 illustrated in FIG. 13, except for a difference in the configuration of rotational driving of the rotational screen 32. The configurations identical to those of the 3D display device 61 illustrated in FIG. 13 are indicated by corresponding reference symbols, and description thereof would not be repeated.

In the present embodiment, the rotational screen 32 is rotationally driven by a motor 72 driven by a driving circuit 73. The driving circuit 73 rotates the motor 72 with a period of one-third of a repetition period T of the image data D1 corresponding to viewpoints of one rotation. As a result, the present embodiment can reduce the rotation speed of the rotational screen 32 by sharing the formation of the viewpoints in a time multiplexed manner with the three projectors.

In the present embodiment, by arranging the plurality of projectors oppositely to the rotational screen, which is composed of the convex lens of which rotational center is positioned eccentrically with respect to the optical axis, in an offset manner with respect to the rotation axis thereof, and by sharing the formation of the viewpoints in a time multiplexed manner for display of 3D image among three projectors, the 3D image can be displayed while reducing the rotation speed of the screen to one n-th, n being the number of projectors.

### Sixth Embodiment

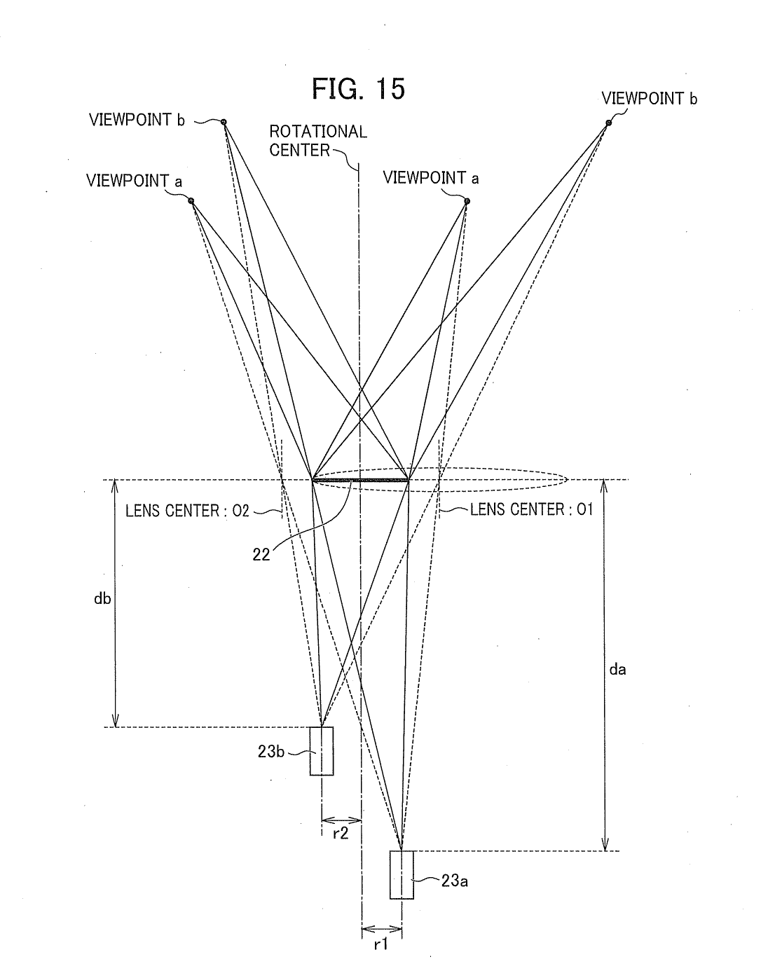

FIG. 15 is a cross-sectional view that describes a principle of another 3D display device according to the present invention. The embodiment illustrated in FIG. 15 is different in configuration from FIG. 3 in using a plurality of projectors disposed at different distances from the rotational screen.

Unlike the configuration of FIG. 3, in FIG. 15, the projectors 23a and 23b are disposed at positions offset with respect to the rotational center of the rotational screen 22 by predetermined distances. Here, an offset amount of the projector 23a (distance between the rotational center of the rotational screen 22 and the optical axis of the projector 23a) is referred to as r1 and an offset amount of the projector 23b (distance between the rotational center of the rotational screen 22 and the optical axis of the projector 23b) is referred to as r2.

A distance between the rotational screen 22 and the projector 23a is referred to as da and a distance between the rotational screen 22 to the projector 23b is referred to as db. In the configuration shown in FIG. 15, the distance da is greater than the distance db.

As shown in FIG. 15, as the distance between the rotational screen 22 and the projector 23a, and the distance between the rotational screen 22 and the projector 23b change, a distance between the rotational screen 22 and the viewpoint changes (viewpoint a and viewpoint b in FIG. 15).

By employing the plurality of projectors 23a and 23b at different distances from the rotational screen 22 as described above, the large number of viewpoints can be formed on a plurality of circles at different distances from the rotational screen 22.

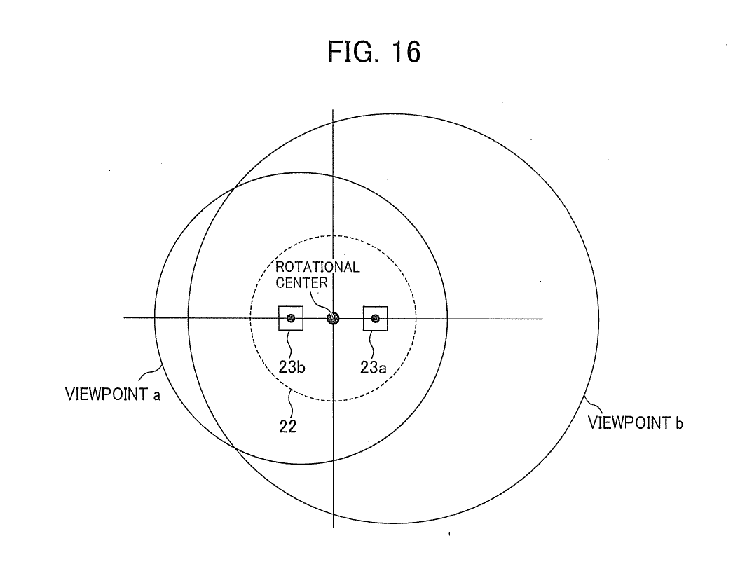

FIG. 16 is a diagram illustrating the displacement of the viewpoints in the configuration of FIG. 15. As shown in FIG. 16, as the distance between the rotational screen 22 and the projector 23a as well as the distance between the rotational screen 22 and the projector 23b change, a distance between the circle on which the viewpoint a is formed and the rotational screen 22 as well as a distance between the circle on which the viewpoint b is formed and the rotational screen 22 change, and radii of the circles on which the viewpoints a and b are formed change.

By employing the plurality of projectors 23a and 23b at different distances from the rotational screen 22 as described above, the large number of viewpoints can be formed on different circles at different heights.

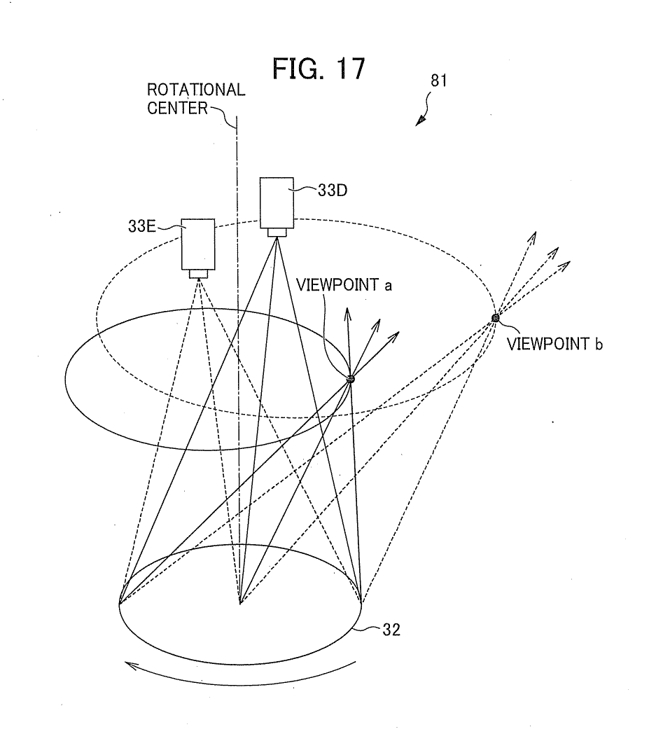

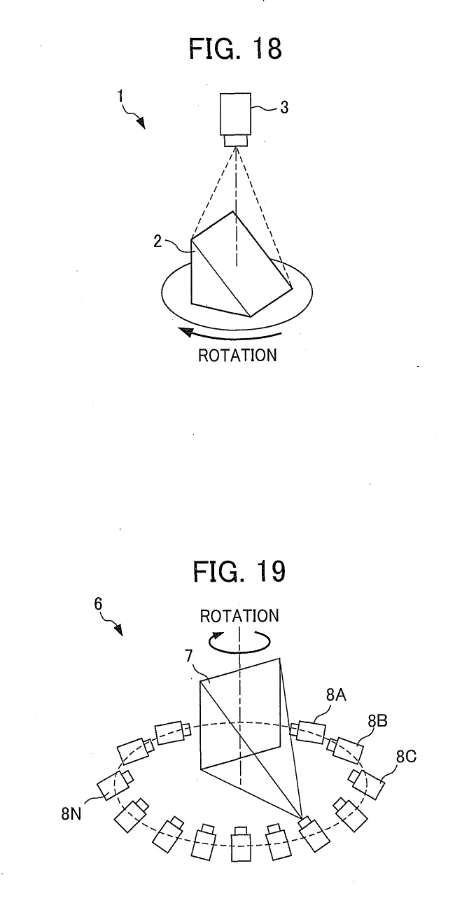

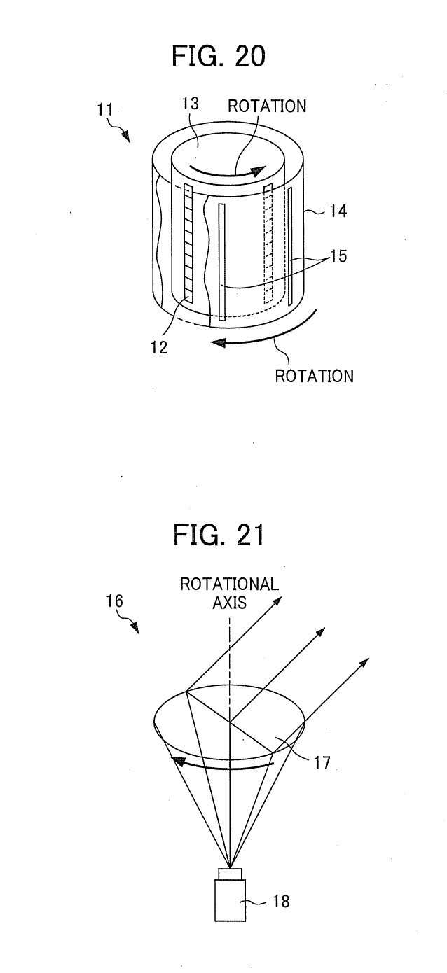

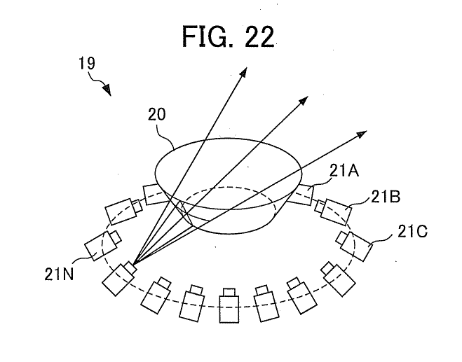

FIG. 17 is a drawing illustrating a 3D display device of the sixth embodiment of the present invention. In the 3D display device 81, first and second projectors 33D and 33E are disposed above the rotational screen 32, at positions offset with respect to the rotation axis by predetermined distances. A distance between the first projector 33D and the rotational screen 32 is greater than a distance between the second projector 33E and the rotational screen 32.

As shown in FIG. 17, by employing the plurality of projectors (the first and second projectors 33D and 33E) at different distances from the rotational screen 32, the large number of viewpoints can be formed on different circles at different heights from the rotational screen 32.

In addition, by displaying parallax images corresponding to the heights of the viewpoints, a 3D image with parallax according to a vertical position of an observer's eyes can be displayed. In other words, a 3D image with vertical parallax can be displayed.

It should be noted that, in a case of using the configuration of FIG. 17, it is required to remove a vertical diffuser from the rotational screen in order to prevent diffusion of light in a vertical direction.

The embodiment has been described using two projectors; however, it is obviously possible to use three or more projectors to thereby obtain the number of viewpoints (vertical parallax) that is equal to the number of projectors in the vertical direction.

In addition, for arrangement of the projectors, a method of arranging the projectors at the same distance from the screen (as in the first to fifth embodiments) and a method of arranging the projectors at different distances from the screen (as in the sixth embodiment) can be used in combination. In other words, a plurality of projectors can be disposed at the same distance as well as at different distances from the screen. In this case, vertical parallax can be provided, in addition to increased frame rate, increased number of gray levels, and increased number of viewpoints. It should be noted that, in a case of arranging the projectors in various relationships with respect to the screen, it is obviously possible to provide a half mirror on an optical path to overlap the optical axes of output light from a plurality of projectors.

### OTHER EMBODIMENTS

Specific configurations that are preferable for carrying out the present invention have been described in detail; however, the configurations of the above described embodiments can be combined and modified in various ways without departing from the spirit of the present invention.

More specifically, in the above described embodiments, formation of viewpoints on a side of the projector by providing a mirror in the rotational screen has been described; however, the present invention is not limited thereto and a configuration of forming the viewpoints oppositely to a side of the projector, without using a mirror can also be employed. In this case, the projectors can be disposed below the rotational screen and a configuration of the side on which a 3D image is displayed can be simplified.

In addition, in the above described embodiments, the Fresnel lens and the lenticular lens constituting the rotational screen are described such that the Fresnel lens is disposed over the lenticular lens; however, these lenses can be disposed in an inverted manner. Furthermore, an optical element having a lens function, such as hologram, can also be used in place of the Fresnel lens, and either the positive lens or the negative lens can be used as described above. Moreover, an optical element having a one-directional diffusion function, such as hologram, can also be used in place of the lenticular lens. Instead, an optical element having both the lens function and the one-directional diffusion function can also be used. Yet alternatively, a reflective optical element having a reflective mirror function, a reflective one-direction diffusion function, or both of the above functions can also be used by further providing a mirror function.

In the above embodiment, a case of driving the plurality of projectors by image data constituting one 3D image has been described; however, the present invention is not limited thereto and can also be employed in a case of driving the plurality of projectors by image data constituting different 3D images. In other words, by displaying different images at different positions of viewpoints, different 3D images can be displayed for different observation positions.

In addition, in the above described embodiments, the parallax in 3D display has been limited to horizontal parallax and 3D display realized is horizontal parallax type; however, by detecting a vertical position of the observer's eyes and displaying images with vertical parallax corresponding thereto, the vertical parallax can be realized virtually.

### EXPLANATION OF REFERENCE NUMERALS

1, 6, 11, 16, 19, 31, 41, 51, 61, 71 3D display device
2 Mirror
3, 8A to 8N, 18, 21A to 21N, 23, 33A to 33C, 33B, 33G, 33R Projector
7 Screen
12 LED array
13, 14 Rotator
15 Slit
17 Planar screen
20 Conical screen
22, 32 Rotational screen
24 Convex lens
32A Rotational screen main body
32B Lenticular lens
32C Mirror
62 Selector
72 Motor
73 Drive circuit

1. A 3D display device comprising:
a rotational screen of which rotation axis is disposed in a displaced manner with respect to an optical axis, the rotational screen being configured to change an emitting direction of incident ray sequentially by rotation about the rotational central axis; and
a plurality of projectors that is disposed in an offset manner with respect to the rotation axis of the rotational screen and emits images onto the rotational screen.

2. The 3D display device according to claim 1, wherein the rotational screen has, in addition to a function as a lens, a function of diffusing light in a direction of a line virtually connecting the rotational center with the optical axis.

3. The 3D display device according to claim 1, wherein the rotational screen is a reflective lens.

4. The 3D display device according to claim 3, wherein the rotational screen has, in addition to a function as a lens, a function of diffusing light in a direction of a line virtually connecting the rotational center with the optical axis.

5. The 3D display device according to claim 1, wherein the plurality of projectors is respectively driven by image data of each of color signals constituting a color image.

6. The 3D display device according to claim 1, wherein the plurality of projectors is:
configured such that an emission light intensity increases sequentially and gradually;
assigned with a bit constituting image data for 3D display, according to the configuration of the emission light intensity; and
driven by data of the bit thus assigned.

7. The 3D display device according to claim 1, wherein the plurality of projectors emits images sequentially and cyclically, by rotation of the rotational screen.

8. The 3D display device according to claim 2, wherein the rotational screen is a reflective lens.
